(19) United States
(12) Patent Application Publication
(10) Pub. No.: US 2004/0063345 A1
(43) Pub. Date: Apr. 1, 2004

(54) Connection assembly for the electrical connection of an electric motor

(76) Inventors: Jurgen Oelsch, Hohenroth (DE); Willi Eppler, Ratshausen (DE)

Correspondence Address: MARK C. COMTOIS, Duane Morris LLP, Suite 700, 1667 K Street N.W., Washington, DC, 20006, US

(21) Appl. No.: 10/634,818

(22) Filed: Aug. 6, 2003

(30) Foreign Application Priority Data
Sep. 27, 2002 (EP) 02 021 679.2

(51) Int. Cl. H01R 12/00

(52) U.S. Cl. 439/76.1

(57) ABSTRACT

Connection Assembly for the Electrical Connection of an Electric Motor A connection assembly for the electrical connection of an electric motor, which has a plastic mounting plate with integrated connection elements, a printed circuit board with sensor and/or control components for the electric motor and a seal, is characterized in that the seal has a one-part sealing ring of a sprayable or moldable sealing material, which is undetachably shaped to the mounting plate and can be clamped between two opposite sealing faces of a two-part motor casing.

### BACKGROUND OF THE INVENTION

The invention relates to a connection assembly for the electrical connection of an electric motor, which has a plastic mounting plate with integrated connection elements, a printed circuit board with sensor and/or control components for the electric motor and a seal.

Such a connection assembly has been proposed, in which said seal has two individual flat seals, which are loosely inserted between the corresponding front faces of the mounting plate and the motor casing part and which are then locked by clamping the two casing parts together using screws or the like, so that the connection assembly and electric motor are sealed against external influence in such a way that e.g. no spray water can enter the motor casing.

The problem of the invention is to provide a connection assembly of the described type which simplifies manufacture and mounting without impairing the sealing action.

### SUMMARY OF THE INVENTION

This problem is solved by a connection assembly according to claim 1.

In the connection assembly according to the invention, in place of two individual, detachable flat seals a single sealing ring is provided, which is undetachably shaped onto the mounting plate, preferably by injection-moulding and/or vulcanizing the sealing material on the mounting plate. The mounting plate and the circular, bilaterally acting sealing ring form a single assembly so that, compared with the prior art, in place of three components, namely the mounting plate and two flat seals, there is only a single component, namely the sealing ring undetachably connected to the mounting plate, which can be more easily manufactured, stored and fitted than the three aforementioned, separate, prior art components.

The connection assembly can undergo rotary setting with respect to the stator winding in the prefitted, not yet clamped state, without it being necessary to remove the mounting plate and seal from the motor casing. This permits a rotary adjustment of the connection assembly with respect to the stator winding, whilst essentially maintaining the sealing function of the seal.

The undetachability of the seal relative to the mounting plate can advantageously be ensured in that the mounting plate has at least one through hole, which is filled by the sealing material of the sealing ring during the shaping of the latter onto the mounting plate. This ensures a completely satisfactory anchoring of the seal to the mounting plate and the undetachability thereof.

Further advantageous developments of the invention are given in the subclaims.

In a preferred embodiment, on either side of the mounting plate, the sealing ring has a ring part, each of which is provided on its outside with a sealing mating surface which sealingly cooperates with one of the two opposing sealing surfaces.

Advantageously, the mounting plate has at least one through hole, which is filled with the sealing material of a sealing ring, so that there is at least one cohesive material connection of one ring part to the opposite ring part.

Preferably, the sealing ring is injection-molded onto the mounting plate.

In a further embodiment, a printed circuit board equipped with at least one of a sensor and control components is held on the motor side to the mounting plate by means of fixing elements formed onto the latter.

In this embodiment it is preferred if in the mounting plate are embedded connection elements which have bends bent axially towards the electric motor and by means of which the printed circuit board is orientated and which are electrically contacted to conductors located on said board. In a further variation, at least one of the connection elements has a bend which passes through an opening in the mounting plate and is electrically conductively connected on the side of the mounting plate remote from the electric motor to at least one conductor of the stator winding. Moreover, it is advantageous if at least one plug lug of the connection element terminates in a plug part which is an integral part of the mounting plate.

### SHORT DESCRIPTION OF THE DRAWINGS

The invention is described in greater detail hereinafter relative to an embodiment and the attached diagrammatic drawings, wherein:

FIG. 1 is an axial section through a connection assembly according to the invention, which is housed in a casing together with an electric motor, whose components are shown in broken lines;

FIG. 2 is a section like FIG. 1 of the connection assembly alone.

### DETAILED DESCRIPTION OF THE PREFERRED EMBODIMENT

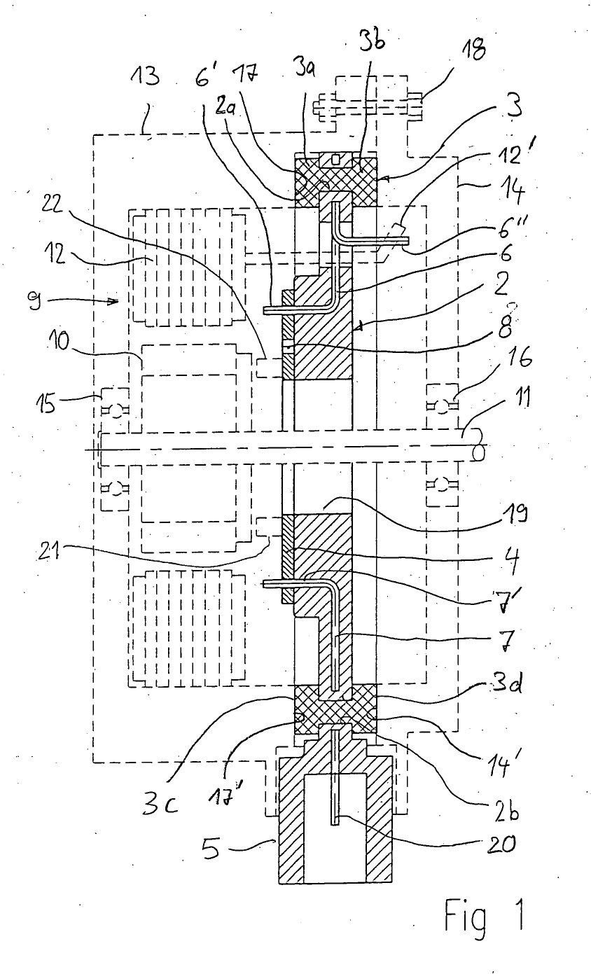

According to FIG. 1 an electric motor 9 has in the usual way a rotor 10 with a driven shaft 11 and a stator winding 12 surrounding the rotor. The electric motor 9 is surrounded by a two-part casing with a casing pot 13 and cover 14. In each of the two casing parts is supported an antifriction bearing 15, 16 for mounting the shaft 11.

A depression 17 of the casing pot 13 houses a connection assembly 1 drawn in full lines which has a plastic mounting plate 2, a printed circuit board 4 fixed thereto, a sealing ring 3 made from a sealing material, such as a thermoplastic elastomer, a silicone elastomer or a PU plastic injection moulded onto the mounting plate, a plug part 5 integrated with the mounting plate 2 and connection plates or lead frames 6 and 7.

The mounting plate 2 and printed circuit board 4 have a common opening 19 for the driven shaft 11 of the electric motor 9.

The printed circuit board 4 is fixed to the front face of the circular mounting plate 2 facing the motor by a mechanical fixing element indicated at 8 and is axially traversed by axially angled parts 6′, 7′ of the lead frames. The lead frame 7 is led laterally out of the mounting plate 2 in the form of individual plug lugs 20, which terminate in a plug housing 5.

The connection plate 6 has a further end 6″ led out of the mounting plate 2 in direction axially opposed to that of the end 6′, the end 6″ being used for connecting to one or more conductors 12′ of the stator winding 12 on the mounting plate side remote from the electric motor 9.

The mounting plate 2 has through holes 2a, 2b which are filled with the sealing material of the sealing ring 3. In this way, the ring parts 3a, 3b formed on both sides of the mounting plate 2 are undetachably interconnected and held in undetachable manner on the mounting plate 2.

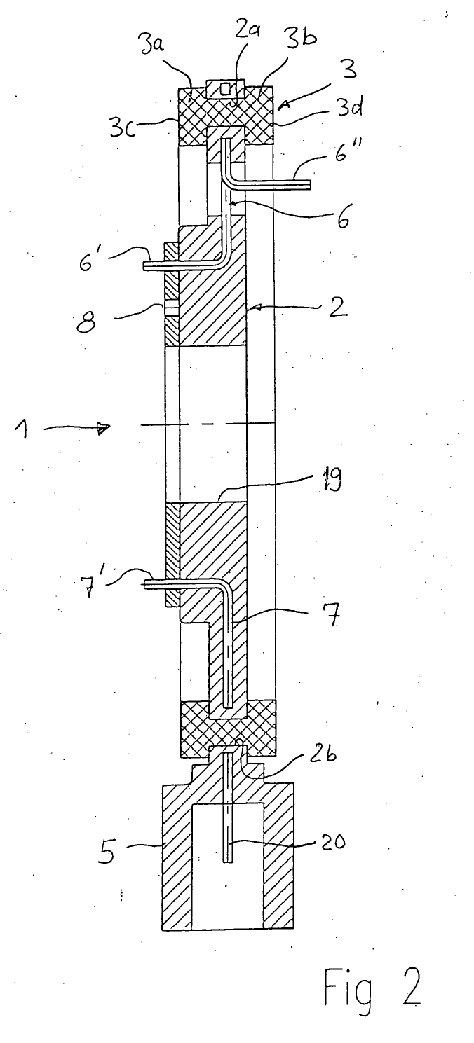

The bottom of the depression 17 in the casing pot 13 and the motor-side radial surface of the cover 14 form opposite sealing surfaces 17′, 14′, which sealingly cooperate with axially outwardly directed, opposite sealing surfaces 3c, 3d of the sealing ring 3, if the casing pot 13 with the cover 14 are clamped to each other by means of circumferentially distributed screws 18, whereof only one screw is shown in FIGS. 1 and 2.

For mounting the prefabricated connection assembly 1, the latter is pressed into the depression 17, so that a sealing action is already obtained between the sealing surface 17′ of the casing pot 13 and the mating surface 3c of the ring part 3a of the seal when the cover 14 is prefitted but not yet clamped. In this position the entire connection assembly 1 can be rotated and therefore adjusted relative to the parts of the electric motor 9, the motor components and mounting plate 2, together with the printed circuit board 4, and the motor control elements 22 and sensors 21 prefitted thereto are already protected against the penetration of foreign matter, such as spray water.

At 21, the printed circuit board 4 can carry symbolically indicated sensor elements 21, e.g. Hall components for establishing the rotary position and/or speed of the motor and which cooperate with control magnets. The latter can be adjusted by rotating the connection assembly 1. The control components are symbolically indicated at 22.

Fitting can be completed by tightening the cover 14 with its sealing surface 14′ on the mating surface 3d of ring part 3b and consequently its other mating surface 3a against the sealing surface 17′ on casing pot 13 by means of screws 18.

The features disclosed in the preceding description, claims and drawings can, both individually and in random combination, be of significance for the implementation of different variants of the invention.

### List of Reference Numerals

| | |
|---|---|
| 1 | Connection assembly |
| 2 | Mounting plate |
| 2a, 2b | Through holes |
| 3 | Sealing ring |
| 3a, 3b | Ringpart |
| 3c, 3d | Sealing face, mating face |
| 4 | Printed circuit board |
| 5 | Plug part |
| 6, 7 | Connection element, connection plate, lead frame |
| 6’, 6”, 7’ | Angled part of the connection element, bends |
| 8 | Fixing element |
| 9 | Electric motor |
| 10 | Rotor |
| 11 | Driven shaft |
| 12 | Stator winding |
| 12’ | Conductor |
| 13 | Casing pot |
| 14 | Cover |
| 14’ | Sealing surface of cover |
| 15, 16 | Antifriction bearings |
| 17 | Depression |
| 17’ | Sealing surface of casing pot |
| 18 | Screw |
| 19 | Opening |
| 20 | Plug lug, plug pin |
| 21 | Sensor |
| 22 | Control component |

We claim:

1. Connection assembly for the electrical connection of an electric motor, which has a plastic mounting plate with integrated connection elements, a printed circuit board with at least one of sensor and control components for the electric motor and a seal comprising a one-part sealing ring of a sprayable or mouldable sealing material, which is undetachably shaped onto the mounting plate and which can be clamped between two opposing sealing surfaces of a two-part motor casing.

2. Connection assembly according to claim 1, wherein on either side of the mounting plate, the sealing ring has a ring part, each of which being provided on its outside with a sealing mating surface which sealingly cooperates with one of the two opposing sealing surfaces.

3. Connection assembly according to claim 2, wherein the mounting plate has at least one through hole, which is filled with the sealing material of a sealing ring, so that there is at least one cohesive material connection of one ring part to the opposite ring part.

4. Connection assembly according to claim 1, wherein the sealing ring is injection-moulded onto the mounting plate.

5. Connection assembly according to claim 1, wherein a printed circuit board equipped with at least one of sensor and control components is held on the motor side to the mounting plate by means of fixing elements formed onto the latter.

6. Connection assembly according to claim 5, wherein in the mounting plate are embedded connection elements, which have bends bent axially towards the electric motor and by means of which the printed circuit board is orientated and which are electrically contacted to conductors located on said board.

7. Connection assembly according to claim 6, wherein at least one of the connection elements has a bend, which passes through an opening in the mounting plate and is electrically conductively connected on the side of the mounting plate remote from the electric motor to at least one conductor of the stator winding.

8. Connection assembly according to claim 6, wherein at least one plug lug of the connection element terminates in a plug part, which is an integral part of the mounting plate.
